(19) United States
(12) Patent Application Publication
(10) Pub. No.: US 2013/0168442 A1
(43) Pub. Date: Jul. 4, 2013

(54) MEANS FOR CONFIRMING TRANSACTIONS THROUGH THE USE OF EMBEDDED AND ENCRYPTED QUESTIONS DISPLAYED AS PATTERNS ON A GRAPHICAL DISPLAY

(71) Applicants: RICHARD ANTHONY RUDD LITTLE, Whitchurch (GB); John Karl Atkinson, Whitchurch (GB); Russell Paul Sion, Whitchurch (GB); Toby Leigh Smith, Whitchurch (GB)

(72) Inventors: RICHARD ANTHONY RUDD LITTLE, Whitchurch (GB); John Karl Atkinson, Whitchurch (GB); Russell Paul Sion, Whitchurch (GB); Toby Leigh Smith, Whitchurch (GB)

(73) Assignee: Jenton International Limited, Whitchurch (GB)

(21) Appl. No.: 13/533,621

(22) Filed: Jun. 26, 2012

(30) Foreign Application Priority Data
Aug. 8, 2011 (GB) 1113594.4

(51) Int. Cl. G06F 17/30

(52) U.S. Cl. CPC G06F 17/30002
USPC 235/375

(57) ABSTRACT

Means are disclosed for facilitating a transaction whereby a series of one or more questions are encoded and preferably encrypted, for example as a graphical pattern such as a 2-dimensional barcode, and wherein the questions are utilised for the purposes of confirming details pertinent to a transaction, such as a purchase from a shop or over the internet or a transfer of monies between personal bank accounts or a granting of permission of access or use or transfer of responsibility and so on, by displaying said questions on a personal portable device such as a mobile telephone for example. Answers given to said questions may then be used to form the basis for the transaction by defining for example articles or services being purchased or amounts of monies being transferred as well as details such as the accounts involved in the transaction and the desired timing details and so on.

This United States Utility application claims priority to United Kingdom Patent Application 1113594.4 filed on Aug. 8, 2011, which is commonly-owned and incorporated herein in its entirety by reference.

### TECHNICAL FIELD

An invention has previously been described for graphically presenting variable information in such a way that it can be scanned optically and used for various purposes such as the performing of a transaction (Patent application GB1108595.8). In addition, an invention has also been described (Patent application GB1112002.9) that constitutes a means for facilitating such transactions by confirming the timing of a transaction via the expedient of optically scanning a display that displays timing information encoded as a pattern that may optionally be encrypted in such a way that it can be scanned optically by for example a personal portable device such as a mobile phone equipped with a camera input and used to verify the timing of a transaction.

The invention described here constitutes a means for further facilitating a transaction whereby a series of one or more questions are encoded and preferably encrypted, for example as a graphical pattern such as a 2-dimensional barcode, and wherein the questions are utlilised for the purposes of confirming details pertinent to a transaction, such as a purchase from a shop or over the internet or a transfer of monies between personal bank accounts and so on, by displaying said questions on a personal portable device such as a mobile telephone for example. Answers given to said questions may then form the basis for the transaction by defining for example the articles or services being purchased or amounts of monies being transferred as well as details such as the accounts involved in the transaction and the desired timing details and so on.

### BACKGROUND

The inventions described above offer significant benefits in the processing of transactions in that it is possible to utilize them either individually or in combination to enable a personal portable device, such as a mobile telephone for example, to be used as a means for effecting or confirming purchases. Examples have been given previously of the usage of the prior inventions for the purchase of goods or services, including the purchase of parking time in a parking facility or the rental of a hotel room or the purchasing of an item from a vending machine and indeed many additional examples could be given. However, in general terms, the invention described here can be used to facilitate the transferring of funds a subset of which may relate to purchasing. As such the invention is an alternative in many ways to a cheque or a credit card and hence can be used to facilitate money transfers. An example of a further usage of the invention is in the context where it may be used to authorise permissions or permit access to locations or items wherein the transaction involves the transfer of permission or responsibility for example.

The present invention describes a means for facilitating transactions wherein one or more questions are embedded in preferably encrypted form on a graphical display such as a 2-dimensional barcode that may be optically scanned by for example a mobile telephone. Usage of this invention is not however restricted to optical scanning and other forms of information storage and retrieval are also appropriate, such as the use of radio frequency identification (RFID) or Bluetooth devices or other suitable form of pre-loaded data source, and neither is it restricted to the use of 2-dimensional barcodes as indeed any multi-dimensional or multi-directional scannable code capable of storing information may also be used.

With the use of a previous invention (Patent application GB1108595.8) optically scannable displayed information can easily be modified to reflect changes in the information as appertaining to the point in time at which the information is scanned and the nature of the transaction that is to be performed. These changes in the information may reflect changes due to the actual point in time at which the information is accessed, such as a change in a charging tariff or the price of an item or service that is being purchased for example. In the invention described here, this may be achieved through the use of a changeable display such as a liquid crystal display (LCD) for example, whereby the pattern on the display may be modified to present different information at different times. In this way a display can be made to display information relevant to any transaction simply by altering the pattern displayed. This feature can then be used for example to sequentially present information relating to individual items that are being purchased at a point of sale (POS) terminal or shop till.

A major advantage of this method of displaying and transferring data is that differently coded and if desirable encrypted patterns may be generated by the same display to communicate different or changing information such that scanning the information using a portable device such as a mobile phone with an optical scanning capability such as a camera input can decode and interpret this encoded or encrypted information to enable a transaction to be effected.

In the invention described here this information may take the form of one or more questions that may be used to facilitate the transaction by for example allowing a user of the invention to communicate information such as details of purchases that are to be made. These details may for example include choices of colours or sizes of items, length of time that a service is required, and so on.

The encoded information may also be contained in a fixed display such as a printed 2-dimensional barcode for example. In this way it becomes possible to scan a pattern in a catalogue or any other form of retail outlet display for example and derive a series of one or more questions that can be answered to facilitate a transaction. For example, colours or sizes of items to be purchased may be established by the simply expedient of supplying answers to question such as “what colour do you prefer?”, “what size garment do you want?” and so on. These questions preferably will be displayed on the screen of a personal portable device such as a mobile phone for example and the user's answers to the questions may then be further communicated by the device to facilitate the transaction. The question or questions may be contained in the encoded information as also may the form of the answer or answers wherein a list of acceptable answers may for example be listed in the form of a list or drop down menu or other suitable form of presentation to a user.

A further example is where the encoded information may take the form of a graphical pattern displayed on a visual display unit such that it may be scanned optically by a portable device comprising suitable means for scanning. An advantage of this is that the encoded information may be easily changed by varying the pattern and this may also be done over the internet for example.

The invention described here has the further advantage in that the portable device used to scan or collect information may be any pre-existing device with an optical or other suitable form of scanning capability, for example a mobile phone or handheld computer such as an Apple “iPad” having either a built-in or connected camera or barcode reader or other form of optical or wireless scanning input capability. This use of pre-existing devices for the scanning of the information simplifies implementation and may also confer cost benefits due to the wide availability of such devices, however the invention is not limited solely to the use of pre-existing devices and there are instances where a device purposely designed for carrying out the scanning of the pattern encoded information may be preferable.

The ability to use the scanned information to change the questions and other information displayed can be beneficial in situations where some form of payment or similar transaction is required. Examples include where a display is required to show pricing information that is variable from time to time. For example the display on a vending machine may be scanned using a mobile phone camera to communicate the price of an item with different selected items showing different encoded prices on the display. Advantages of this approach include the ability to alter the prices easily from a remote location over a communication medium such as the internet or a mobile phone network for example and also for a user to make payment for the item in the same way, for example over a mobile phone network.

It is also possible in this way to show variations in pricing due to the quantity of an item being purchased or the quality of a service being paid for. An example may be where a hotel room is being booked and the user is asked a question to define the standard of room that is to be booked.

A further desirable aspect of the invention is that it is possible to send a return authorization code to the scanning device, for example a mobile phone. For example this information may take the form of an unlocking code that allows the user to access a service or item that is being purchased or to which permission to use is being granted. It is possible that this code could also be automated in the manner of it being received as a graphically encoded pattern, such as a barcode for example, that can then be displayed by the receiving device (a mobile phone for example) and scanned by a scanning device local to the point of purchase for confirmation purposes. In this way access to purchased items or services can be controlled via the scanning of a received authorisation or confirmation code. It is also possible to use this returned authorisation as a way of controlling access to items or locations wherein the authorisation gives the user permission to use said items or access said locations via the use of an unlock code for example.

A further example of how the present invention may be used in the above context is as follows. A user wishing to purchase an item, for example from a vending machine, or utilize a facility such as a hotel room or a secure locker, scans a barcode on a variable display such as an LCD for example. The information scanned can then be presented to the user in the form of questions that establish the service or item that is being purchased for example. These questions may take many forms with the form of the question and possibly also the acceptable answers being contained within the information being scanned. It can be a further advantage if the timing of the transaction is also established by the act of scanning the display wherein the display presents the time information in graphical or other digitally encoded form. An authorisation code can then be returned to the user via the scanning device or mobile phone that allows the item to be released from a vending machine or the door access code to a hotel room for example. It is also possible that the vending machine itself may be portable and an aspect of the displayed information may be the location of the transaction as established at the time of scanning of the display. A further example may be the use of the invention in a shop wherein a list of items being purchased may be scanned from a display at a POS terminal in a retail environment. In this example it may also be desirable to return a list of items being purchased via the POS terminal or till to a scanning personal portable device in the manner of an “electronic receipt” for the goods purchased. Additionally the personal portable device may then cause an authorisation code to be returned to the POS terminal in a similar manner to that which is currently done for credit card authorisation.

The security aspects of the invention can be further enhanced by the use of this “electronic receipt” whereby an authorisation code is transmitted to the scanning device such as a mobile phone (cellphone) for example. It is may also be desirable for additional information to be contained in the authorisation code. This additional information may for example take the form of a list of goods or services that are being purchased and may also include identification details such as a photograph of the owner of the portable device that can then be used for verification purposes. This additional information can optionally be displayed in human readable form on the display of the portable device or on some other display device local to the point of the transaction such as a computer screen or on a till display for example in a manner that is analogous to an electronic receipt for goods or services for example. The authorisation code may be transmitted to the personal portable device from a remote location such as over a mobile phone network or communicated locally by presenting the information in a graphically coded form on a variable graphical display device such as an LCD for example. Alternatively information may be communicated between the personal portable device and other devices using other means such as flashing or pulsed light, using a mobile phone's existing communication channels for example, or other localised wireless communications such as Bluetooth communications and so on.

### SUMMARY OF THE INVENTION

According to a first aspect of the invention, there is provided a means for facilitating a transaction whereby a series of one or more questions are encoded and preferably encrypted, for example as a graphical pattern such as a 2-dimensional barcode, and wherein the questions are utlilised for the purposes of confirming details of the transaction.

The encoded information may take the form of a two-dimensional barcode or other suitable pattern or non-character based encoding technique including multi-1.0 dimensional or multi-directional barcodes such that it may be scanned easily by a portable device such as a mobile SMART phone such as an “Apple i-Phone” or handheld computer for example. The scanning may typically be achieved through the use of a camera or other optical input device such as a laser diode/sensor combination including those that use either visible or invisible (e.g. infrared) light or any other optical scanning device.

Usage of the invention in this way is not however restricted to optical scanning and other forms of storage and retrieval are also appropriate, such as the use of radio frequency identification (RFID) or Bluetooth devices for example, and neither is it restricted to 2-dimensional barcodes as indeed any multi-dimensional or multi-directional scannable code capable of storing information may also be used.

A further aspect of the invention is that if desired it is possible to return an acknowledgement of the act of scanning that can take many forms including a receipt for purchase of goods or services and that may contain other information such as photographic images or means for confirming identity.

### BRIEF DESCRIPTION OF THE DRAWINGS

The invention will now be described by way of example, with reference to the drawings, which illustrate one particular embodiment of the invention in which:

FIG. 1 is a diagram of an apparatus being used in accordance with the invention to present information that may include for example one or more questions in the form of a two-dimensional barcode displayed on a liquid crystal display that can be optically scanned by a portable device;

FIG. 2 shows examples lists of questions as displayed on a mobile telephone such that they may be utlilised for the purposes of confirming details of a transaction.

### DETAILED DESCRIPTION OF A PREFERRED EMBODIMENT

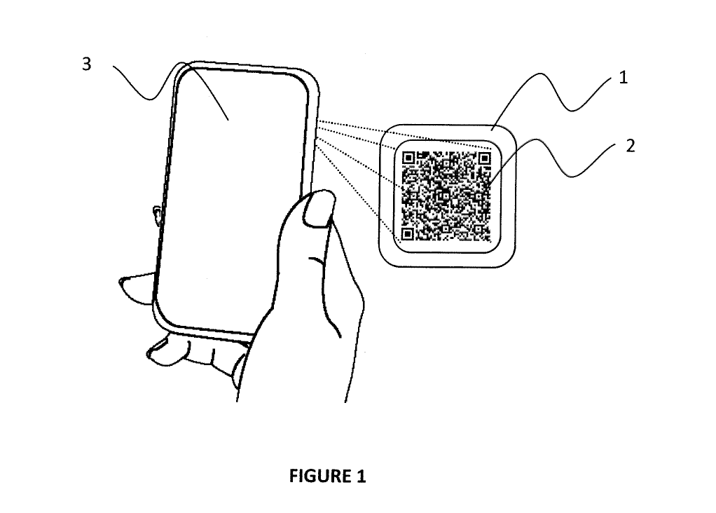

With reference to the drawings, FIG. 1 shows one embodiment of the invention consisting of a display device 1 that presents encoded information that may contain a series of one or more questions encoded and preferably encrypted for example as a graphical pattern in the form of a two-dimensional barcode 2 and a mobile phone 3 on which software may be run so as to perform the function of the optical scanning of the pattern encoded information displayed by interpretation of the image captured by a camera integral to the mobile phone. Obviously other portable devices may also be used in place of a mobile phone such as handheld computers, data entry devices and etc. The two-dimensional barcode 2 includes a list of one or more questions that may be utlilised for the purposes of confirming details of the transaction.

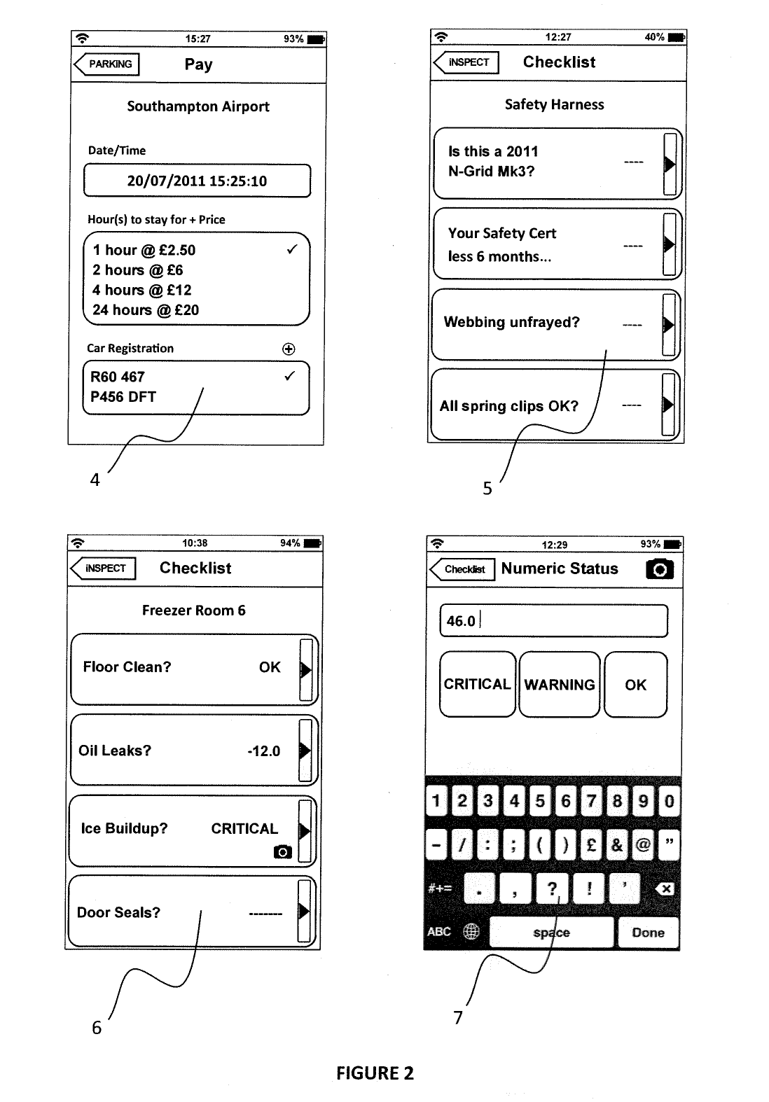

FIG. 2 shows lists of questions as may be displayed on a mobile telephone such that they may be utlilised for the purposes of confirming details of a transaction. These questions may take many forms with the form of the question and possibly also the acceptable answers being contained within the information being scanned. The question or questions contained in the encoded information and also the form of the answer or answers may then be displayed as a list of questions and acceptable answers in the form of a drop down menu or other suitable form of presentation to a user.

Referring to FIG. 2 typical displays are shown including a means for inputting information relating to a transaction 4 wherein date, time, pricing and registration details of a vehicle to be parked at a parking facility are shown by way of an example. A further example display is shown 5 as an example of a transaction involving the granting of permission to use a safety harness following a question and answer dialogue that establishes salient facts and information about the suitability for purpose of the safety harness. Subsequent sections of dialogue may for example include questions such as “have you completed a training course on the usage of this safety harness?” and so on. A further example 6 is given of a checklist dialogue that forms the basis of an inspection of a location, in this case a freezer room, and illustrates the use of questions that require answers to be given that may involve the inputting of text, numerical values, status values and so on. The inputting of text, status and numerical values may be further facilitated by the use of a dialogue box display 7 that enables simplified input via selection.

The preferred embodiment of the invention described here will now be further described by the following examples of how it may be utilized in a series of typical scenarios.

### Example 1

User A wishes to transfer 50 pounds sterling to user B.

User B's bank details are encrypted into a 2-dimensional barcode that can be printed or displayed on the screen of a personal portable device, for example a smartphone. User A simply scans the barcode which triggers a display on User A's phone, e.g. “Hello User A. You have acquired the bank details of ‘User B’. Do you wish to transfer funds? If so, please enter the amount to transfer? Which account (or credit card etc.) do you wish to transfer from? (xxxxx345 or xxxxx234). Enter PIN. Confirm and send.”

User B will receive an e-mail or message from his/her bank to confirm receipt.

Additionally if, for example, user A's requested action will take him/her over a set bank limit or make his/her account overdrawn, then User A may be given the option there and then to accept charges or to withdraw payment without any need to wait for the next account statement.

### Example 2

User C wishes to purchase something shown on a computer screen or from a catalogue. A 2-dimensional barcode with details of a product (or multiple products or a completed ‘basket’) is either printed next to the desired purchase, as for example on an advertisement or in a catalogue, or may appear on the screen of a Personal Computer or a screen in a shop etc.

Scanning the barcode produces a display for example “Welcome User C, you have selected product KK+LL combination from SUPASHOES catalogue total price incl. p&p £34.96 p. Please confirm y/n. Please select size from the following options list. Please select colour from the following options list. Please confirm delivery address. Which card do you wish to use today? (select xxxx4929, xxxx5678). Enter PIN. Confirm and send.”

In such manner this transaction method may for example be utilized as a simple way for buying goods or services via the internet.

### Example 3

User D wishes to stay in a hotel or purchase goods from a vending machine.

User D selects product or enters relevant data into automated hotel foyer display. A variable data display generates a 2-dimensional bar code confirming location, details of purchase and amount. Scanning the 2-dimensional bar code triggers a display such as: “Welcome user D, you have selected . . . , price £ . . . , please confirm. y/n. Which card do you wish to use today? (select xxxx4929, xxxx5678). Enter PIN. Confirm and send”. A purchasing system then uses the provided information to check for authorisation and sends back a release code for the goods or service. This authorisation can be displayed as a code on the screen for a reader/scanner on the vending machine/auto key dispenser or transmitted as pulses of LED flash built into a mobile phone or displayed on screen for hand entry.

### Example 4

User E wishes to purchase a battery charger from a store where the POS till is suitably enabled according to this patent and has a variable display. The shop assistant rings up the sale as normal. All normal methods of payment can still be used.

However for users who have pre-registered, the variable screen displays details of the store, the item(s) purchased and the purchase price. As above, User E confirms purchase and confirms. Money is transferred or guaranteed by the system and a code is sent to the user's mobile phone to confirm the purchase or an authorisation code is sent directly to the POS till in a similar manner to how card authorisations normally occur.

### Example 5

User F wishes to use an item of equipment such as a ladder or a safety climbing harness or operate an electrical device or a machine. User F scans a barcode on or near the item of equipment that initiates a transaction that may take the form of questions and answers such as “Have you been trained to use this equipment? Have you checked the equipment according to the instructions for its use?” and so on. Only when the user has supplied acceptable answers to the questions will the item of equipment be made available such as through the user being given an unlock code for example.

### Example 6

User G wishes to pay a utility bill or some other form of invoice. A 2-dimensional barcode with details of the required payment is printed or otherwise displayed on the invoice. User G scans the 2-dimensional barcode using for example a mobile telephone and is asked to confirm payment of the invoice and other details such as which account to use for the payment and so on, whereupon the transaction is authorised and made in an analogous manner to that of a credit card. In this instance all details of the transaction may be kept confidential and only accessible to User G.

What is claimed is:

1. A means for facilitating transactions by encoding information in the form of one or more questions that may be displayed by a personal portable device and wherein said questions may be utilized for the purposes of facilitating the transaction and wherein said information is obtained by the personal portable device via the act of scanning a preconfigured representation of the information.

2. A means for facilitating transactions as described in claim 1 wherein the scanning device is for example a mobile phone equipped with a camera input device.

3. A means for facilitating transactions as described in claim 1 wherein the preconfigured representation of the information is encoded and displayed graphically in an encrypted form.

4. A means for facilitating transactions as described in claim 1 wherein the preconfigured representation of the information is encoded and displayed graphically in the form of a 2-dimensional barcode.

5. A means for facilitating transactions as described in claim 1 wherein the preconfigured representation of the information is encoded and displayed graphically in the form of a multi-dimensional or multi-directional barcode.

6. A means for facilitating transactions as described in claim 1 wherein the preconfigured representation of the information is contained in the memory of a wirelessly scannable device.

7. A means for facilitating transactions as described in claim 1 wherein the transaction involves payment for goods or services provided local to the point of scanning.

8. A means for facilitating transactions as described in claim 1 wherein the preconfigured representation of the information is displayed graphically on a visual display unit.

9. A means for facilitating transactions as described in claim 1 wherein the preconfigured representation of the information is displayed graphically on a display that is integral to a sales till or other point of sale terminal.

10. A means for facilitating transactions as described in claim 1 wherein the transaction is a financial transaction involving the transfer of money.

11. A means for facilitating transactions as described in claim 1 wherein the transaction involves the granting of a permission of access or use or the transfer of a responsibility.

12. A means for facilitating transactions as described in claim 1 wherein the transaction involves the payment of vehicle parking charges.

13. A means for facilitating transactions as described in claim 1 wherein transaction information is returned to a portable device such that said information may be used as an authorisation or to confirm the transaction or to confirm a transfer of responsibility.

14. A means for facilitating transactions as described in claim 1 wherein the transaction is validated by the return of an authorisation that may be used to enable access to or receipt of goods or a service or access to a location or an item of equipment or to a hotel room or to the content of a vending machine or to a garage or other parking facility.

15. A means for facilitating transactions as described in claim 1 wherein the transaction is validated by the return of an authorisation that may be used to give access to a service provision or to grant temporary permission of access to an item or location or service.

16. A means for facilitating transactions as described in claim 1 wherein the transaction is validated by the return of an authorisation that may contain personal identification information.

17. A means for facilitating transactions as described in claim 1 wherein the transaction is validated by the return of an authorisation that may contain a displayable photograph of the user.

18. A means for facilitating transactions as described in claim 1 wherein the transaction is validated by the return of an authorisation that may contain variable information or a record of one or more purchased items or services.
